(19) United States
(12) Patent Application Publication
(10) Pub. No.: US 2025/0026160 A1
(43) Pub. Date: Jan. 23, 2025

(54) A Surface Adapting Assembly for a Tire

(71) Applicant: RETYRE AS, Ski (NO)

(72) Inventors: Paul Magne Amundsen, Sofiemyr (NO); Tarjei Hofset, Sykkylven (NO); Olaf Brage Marvik, Jar (NO)

(21) Appl. No.: 18/714,711

(22) PCT Filed: Nov. 30, 2022
(86) PCT No.: PCT/NO2022/050276

§ 371 Date: May 30, 2024

(30) Foreign Application Priority Data
Dec. 1, 2021 (NO) 20211449

(51) Int. Cl. B60C 27/06; B60C 27/16

(52) U.S. Cl. CPC B60C 27/063; B60C 27/16; B60C 2200/10

(57) ABSTRACT

A surface adapting assembly for a tire comprising an elongate member for fitting over the tire. The elongate member has a contact surface having treads sidewalls extending longitudinally and extending between respective edges of the elongate member and respective sides of the contact surface, and a first and second end extending in a crosswise direction of the member. The surface adapting assembly comprises a first pair of fastening elements attached to the first sidewall adjacent the first edge and adjacent each end of the elongate member. Each fastening element has a height that is smaller than the distance across the sidewall from the first edge to the contact surface. At least one of the first pair of fastening elements comprises an opening for a part of the same locking element. A method for manufacturing a surface adapting assembly for a tire is also disclosed.

### BACKGROUND

The disclosed embodiments relate to a surface adapting assembly for a tire, and in particular to a surface adapting assembly including a device for securing an elongate member over the underlying tire structure in a way that allows for quick and efficient fitting and removal.

Particularly in northern climates, where conditions can be difficult on roads and pavements during winter, it is important for the safety of both drivers and passengers that vehicle tires provide sufficient grip and are robust enough to withstand the harsh weather. A typical tire includes a base having a contact surface which is positioned to contact the road surface during use, edges which may be provided with beading for attachment to a wheel rim, and sidewalls extending between the base/contact surface and the edges on either side. The contact surface can be provided with patterned treads to improve grip, which can include grooves and often also sipes. The grooves are shaped to control the level of friction between the road, pavement, or floor surface and the contact surface of the tire and to allow water and ice to run away from the tire. The smaller sipes are present to contribute to improved grip. Tires can be formed from an elastomeric material, such as rubber or thermoplastic, which can be reinforced with fabric or mesh layers. The shape of the tire, such as the angle of the bend between the sidewalls and the contact surface and how rounded the tire is, is important in terms of how the vehicle responds when cornering and will vary depending on the type of vehicle concerned. A bicycle or scooter tire is generally substantially rounded in cross-section and comprises a casing, a tread formed of elastomeric material, and in the case of a bicycle at least, beaded edges for attachment to a wheel rim.

Cars, bicycles (classic, hybrid, or electric), scooters, mobility scooters, and other wheeled vehicles can be fitted with alternative tire in the winter to help to improve grip and resistance to weathering. This is usually achieved by replacing a whole summer tire with a winter tire complete with alternative tread patterns. Winter tire are also often fitted with small spikes or beads which protrude outwards from the contact surface. These spikes or beads can be formed of metal, or another wear resistant material, and are able provide a good level of grip even in icy or snowy conditions. Tire designed to be used in winter weather also usually include deeper sipes and grooves as part of the tire pattern, which help snow and ice water to run out and away from the contact surface to prevent planing or sliding.

Because the weather can change rapidly, and because with the onset of winter in some countries the temperature can fluctuate around zero degrees, it can be that tire need to be changed multiple times every year. Replacement may also be required to exchange worn tire with new tire mid-season. Changing the tire of a car usually involves jacking the car and loosening and removing wheel nuts before removing and replacing the entire wheel. To tighten the nuts safely requires the use of a wheel brace which needs to be carried in the boot of the car along with the entire spare wheel. For a bicycle or scooter, the tire and inner tube are removed from the wheel rim and replaced. Again, the removal and refitting of a tire often necessitates removal of the whole wheel from the bike or scooter and is difficult without tire levers and other equipment. In the case of mobility scooters and similar vehicles, this can be debilitating for an owner who requires the scooter to move around but is not able to replace the wheels without assistance. Where electric or manual scooters or bicycles are provided by a company or by the council for public use their maintenance can be costly, and the ability to quickly change the tire surface is therefore especially valuable.

EP3423296 describes a system which allows different covers to be attached over a bicycle tire by way of a zip for coupling to a base tire. This makes adapting a tire to different seasons much simpler and quicker, but requires the use of a specific base tire or an additional element with zip fastenings close to the rim. The system cannot be used with standard tire without adaption (fitting of the additional zipped element), and may be difficult or fiddly to use with smaller wheels such as those of electric scooters. US-A-2010/0200136 describes a replaceable tread portion which in some embodiments can be attached to the underlying tire surface via hooks which extend through slots provided in the tire itself. This system also cannot be used with standard tire.

### SUMMARY

According to a first embodiment, there is provided a surface adapting assembly for a tire comprising an elongate member for fitting over the tire, the elongate member having: a contact surface having treads; a first sidewall extending longitudinally and extending between a first edge of the elongate member and the contact surface; a second sidewall extending longitudinally and extending between a second edge of the elongate member and the contact surface on the other side; and a first and second end extending in a transverse direction; wherein the surface adapting assembly comprises a first pair of fastening elements attached to the first sidewall adjacent the first edge, with one of each pair being attached adjacent each end of the elongate member, wherein each fastening element has a height that is smaller than the distance across the sidewall from the first edge to the contact surface, and wherein at least one of the first pair of fastening elements comprises an opening for receiving a part of the same locking element.

This configuration provides as smooth as possible a riding surface, while still achieving a secure and close fit for the elongate member over the tire underneath. The term elongate here refers to the fact that the elongate member has a larger dimension in the longitudinal direction than in the transverse or radial direction. The ends extending in a transverse direction is to them extending in a thickness direction of the elongate member, from an inner to an outer surface or vice-versa. The elongate member may be curved both in the radial and longitudinal direction in order to fit around and lengthways along the whole of the underlying tire. The size and curvature will depend on the size and shape of the tire it is intended to fit over, but the skilled person will be well aware of different standard tire shapes and sizes for different vehicles. The length of the elongate member (its size in the longitudinal direction) should be substantially the same as the external longitudinal diameter of the underlying tire. This will ensure that the elongate member is pulled taught over the tire when the fastening elements are locked together by installation of the locking element. The elongate member in a transverse cross-section can be shaped as a part of a ring, such as a half ring, or can be U-shaped in order to extend over the tire from wheel rim to wheel rim. The elongate member can also be designed to fit lengthways all of the way around the tire and wheel, and so will also have a circular ring-shaped longitudinal cross section when fitted. The transverse cross-section can be more or less rounded at the intersection between the contact surface of the member and sidewalls, again depending on the shape of the underlying tire. The inner and outer surfaces of the member can be similarly shaped. The inner surface of the sidewalls or of the elongate member itself refers to the surface which sits directly adjacent, faces, and usually contacts the tire when the assembly is fitted. The outer surface of the sidewalls or of the elongate member refers to the surface opposite to this, which faces outwards away from the tire when the assembly is fitted. The outer surface of the elongate member will include the contact surface.

The opening need not necessarily extend all of the way through the fastening element within which it is provided, although it can do so in some embodiments. In cases where it does not, the opening can represent an indent or groove in the fastening element into which the locking element can extend when the two fastening elements are locked together. The locking element can be fixedly coupled to or can be integral with one fastening element, and can be configured to sit in place to extend into the opening of the other fastening element when the two fastening elements are locked together. In some cases, the locking element may be placed within the opening by moving the fastening elements towards each other in a sideways direction perpendicular to the longitudinal direction of the elongate member. In some cases the locking element may clip, slide, or pivot so as to move it into place within the opening of the other fastening element. Once in place, the locking element within the opening prevents the fastening elements from being pulled apart by a force applied in the longitudinal direction of the elongate member.

Reference to a “height that is smaller than the distance across the sidewall from the first edge to the contact surface” is to the fact that the fastening elements do not extend up the sidewall away from the rim of the wheel as far as the contact surface, but only extend part of the way up the sidewall. The fastening elements are each positioned on the first sidewall at or near to the first edge of the elongate member so that they extend only part of the way across the sidewall in a direction towards the contact surface. Reference to a direction “across” the sidewall is to a direction from the edge to the start of the contact surface in a radial direction, or up the sidewall. If the fastening elements are not attached so that they extend up to or around the first edge, then the distance between the fastening element and the edge may be a maximum of 10 cm, preferably 5 cm, and most preferably 2 cm. The distance between the upper edge of the fastening element and the contact surface in a direction across the first sidewall may be at least ⅙ of the height of the sidewall in some cases. The fastening elements may be located closer to the first edge than to the contact surface. They do not extend as far across the first sidewall as the contact surface and do not extend across the contact surface of the elongate member. There is therefore no interference with the riding surface when the assembly is fitted, which improves performance. In embodiments, the first pair of fastening elements each extend from adjacent or at the first edge to between ⅙ and ⅚ of the way across the first sidewall towards the contact surface, more preferably to between ⅙ and ¾ of the way across the first sidewall, and most preferably to between ⅙ and ½ of the way across the first sidewall.

The elongate member, including the ends, may be of a consistent structure, meaning that the materials used to form the member and the thickness and positioning of the various layers within it (if applicable) do not vary, at least in a direction along its length (the longitudinal direction). The elongate member, which is a cover member, will usually be formed from a similar material to the underlying tire. The member may be formed of moulded rubber or thermoplastic, for example, and may or may not include additional layers. Either way the materials and structure will be consistent along the length of the elongate member including the ends and end surfaces. The size and shape of the treads may also be consistent along the length of the member. These can also be shaped so that the pattern of the tread is continuous, and is not interrupted, when the fastening elements are locked together to fix the ends of the elongate member in place adjacent one another and prevent these from moving relative to one another.

The ends will each include end surfaces which will be U-shaped, as shown in FIG. 11, to represent a cross-section through the two sidewalls and a base of the elongate member including the contact surface. The part of the end surface forming the base of the U, or the part which represents a cross-section through the contact surface, will sit directly adjacent and facing the equivalent section of the other end surface when the fastening means are placed and/or locked together. The two parts of the end surface will preferably contact or substantially contact one another, but there may be a small gap between the two depending on the fit of the elongate member. This gap will preferably not be larger than a couple of millimetres in size at any position on the end surfaces. In either case, there will generally be no other structure in between the two end surfaces, either to be used for attachment of the two ends of the elongate member or otherwise. The end surfaces may be flat, and as such there will be no parts of the elongate member itself which overlap when the elongate member is fixed in place. This, too, helps to provide a continuous smooth riding surface for the resulting assembly. In embodiments, the fastening elements coupled to each end of the elongate member also do not overlap when in their locked position. The end surfaces can each be slanted in a direction from the inner to the outer surface of the elongate member. This slanting may help to minimise the effect of any gap, but the end surfaces will usually be oriented perpendicularly to the longitudinal direction along the member.

The contact surface is the part of the elongate member which will contact the road or floor surface when the assembly is fitted on a wheel and the vehicle is in normal use. This also represents the outer surface of a base of the elongate member. The base extends from the contact surface through to the opposing inner surface of the member, so that the member has a generally tubular form with a U-shaped or rounded transverse cross-section comprising the two sidewalls and the base. The extent of the base and contact surface on the outer surface of the member is the same. The contact surface will include some parts of the elongate member which will contact the road or floor surface only when the vehicle is turning, and the wheel is tilted or angled relative to the ground. The sidewalls extend from the contact surface to the edges of the elongate member on either side. The sidewalls represent a portion of the elongate member which will never contact the road or floor surface while fitted to a wheel of a vehicle that is in normal use. The member will have a certain thickness, and this will result in two end surfaces at each end which extend in a transverse direction, perpendicular to the side-walls and the contact surface, and which face each other when the elongate member is fitted over a tire and wheel.

The parts of the two facing end surfaces adjacent the contact surface, which are to be fixed in place directly adjacent one another, are also the end surfaces of the base section of the elongate member. The end surfaces of each of the sidewalls of the elongate member may also be fixed in place facing and directly adjacent one another when the fastening elements are locked together. The elongate member, once fitted, therefore has an outer surface which is substantially continuous and forms a tire-shaped surface divided by a slice or cut in a plane perpendicular to its longitudinal extent, i.e. a slice through the elongate member in a thickness direction. When the elongate member is fitted, the locking element extends across the slit between the two fastening elements to hold the end surfaces together. The ends of the elongate member do not overlap when the fastening elements are joined together by the locking elements, but are fixed in position so that the end surfaces are facing and directly adjacent one another, with no other components in between. No part of the securing device, for example, is located on or interrupts the contact surface. Any gap, if a small gap is present, between the two end surfaces is empty space.

In embodiments, the elongate member is a single curved piece which is shaped to extend all or substantially all of the way around the tire in a longitudinal direction. The elongate member is shaped with a base and sidewalls, and will have a similar shape to the underlying a tire, but with a single radial cut or slit forming the two ends. The dimensions of the inner surface of the elongate member may be chosen to match the exterior dimensions of a standard tire. The elongate member in this form can be moulded as an integral piece, such as out of polymer, elastomer, rubber, or thermoplastic. This shape of the member and the positioning of the fastening elements, especially but not exclusively if the member is also stretched to some extent to fit around the underlying tire, maximises the performance and smoothness of the tire on the road and helps to effectively pull the covering elongated member to a tight fit around the tire. The securing device including the fastening elements and locking element is strong enough to fix the elongate member in place. An extremely secure attachment is provided by fixing two sets of fastening elements, one on either sidewall of the elongate member, each pair spanning the slit separating the two ends when the member is fitted. The thickness of the elongate member may be between 0.5 mm and 10 mm, preferably between 1 mm and 5 mm.

In embodiments, each of the first pair of fastening elements comprises an opening for receiving a part of the same locking element. The locking element therefore extends between the two fastening elements to lock them together when the securing device is in the locked configuration. In embodiments, the first pair of fastening elements each extend from the first edge to between ⅙ and ¾ of the way across the outer surface of the first sidewall.

In embodiments, the fastening elements each comprise a recess to accommodate the first edge of the element. The fastening elements therefore extend around the first edge and part of the way across an inner surface of the first sidewall. In embodiments, the fastening elements are attached to the elongate member so that they curve or extend around an edge of the elongate member and up the underside of the sidewall. The fastening elements thus each sandwich a portion of the sidewall adjacent an end, which provides a secure attachment between the fastening elements and the member, and a more stable connection also between the two fastening elements. The recess may have a width equal to or less than the width of the sidewalls when not compressed, so that the sandwiching also squeezes the sidewall from either side to provide a more secure attachment. Instead or in addition, the fastening elements may be attached using rivets or bolts which extend through the fastening element on either side of the sidewall and through the sidewall itself.

In embodiments, the first edge comprises beading extending from the first to the second end and the recess accommodates the beading. The beading of the first edge may be coupled to the fastening elements at either end, either directly or indirectly. This may be achieved by squeezing the beading from either side within a recess as described above for the sidewalls. Only the beading, and not the rest of the sidewalls may be held in place in this way if the beading represents a wider portion of the sidewalls. The width of the beaded region may therefore by larger or equal to the width of the recess and may be compressed by the fastening element to squeeze the beading. The same configuration with beading and fastening elements may be provided on the second sidewall. The beading may comprise a thicker region at the edge of the elongate member and may be provided with additional material such as internal wiring having a higher tensile strength than the rest of the member. The beading may comprise a coated steel wire, for example. The beading may stretch less easily than the rest of the elongate member and may therefore help to reduce stresses on any mechanical attachment (i.e. the holes and rivets) between the fastening element and the first sidewall. When the fastening elements are locked together, the beading helps the elongate member to fit closely to the underlying tire by pulling it inwards at the edges.

The fastening elements can be coupled to the beading directly or to the elongate member adjacent the beading, meaning that when they are secured together, the ends of the beading are forced together so that the beading forms a hoop which helps to stretch the elongate member over the tire or to secure it in place and provide a tight fit. A similar or identical securing device may be present on the second sidewall, so that the elongate member is stretched more effectively over the underlying tire structure also with the help of the beading and fastening elements on the opposite side. A smaller diameter of the longitudinal cross section at the edges of the elongate member, so that the edges are shorter than the middle of the contact surface in a longitudinal direction, will also help the elongate member to curve radially around the tire.

In embodiments, the first pair of fastening elements each extend below the first edge of the elongate member, and the opening is positioned so that when the locking member is received therein it extends between the fastening elements below the first edge of the elongate member (and usually also below the rim of the underlying tire). Below refers to a direction past the edge of the elongate member and away from the contact surface, or towards a central axis of the vehicle wheel when the surface adapting assembly is in place. This way, the locking mechanism does not interfere with the attachment of the fastening elements to the elongate member, and the securing device as a whole does not need to include parts which stick out of the side of the wheel or vehicle for locking the fastening elements together. Parts sticking out of the side of the wheel during use can be dangerous, and the configuration in which the fastening elements extend below the edge of the sidewall reduces the likelihood of damage or of the securing device hitting objects during use. The thin profile of the fastening elements in a transverse cross-section is shown in FIG. 11, where it can be seen that the elements extend below the edge of the elongate member, which in this case is beaded, but do not extend very far outwards to either side. Positioning the locking mechanism including the locking element below the edge of the sidewall, to which the fastening elements are attached, allows for this.

In embodiments, the first pair of fastening elements are arranged at each end of the member in such a way that once the element is arranged on a tire, and the pair of fastening elements is locked together, the ends of the element will be in contact.

In embodiments, the surface adapting assembly comprises a user operated release mechanism which is activatable to free the locking element from the opening. The release mechanism may comprise a device such as a button, slider, or switch which can be operated manually by a user (pressed, pulled, moved, or flicked) to remove the locking element from the opening and allow the two fastening elements to be moved apart. In one example of such a release mechanism, the locking element is pivotably or slidably coupled to one of the fastening elements and pivots or extends into the opening in the other fastening element to lock the two together. Activating the release mechanism may cause the locking element to again pivot away from the opening. The locking element may be biased in a position in which it does not extend into the opening, but be held in place within the opening by a retaining member when the fastening elements are locked together. Activating the release mechanism (i.e. pressing a button, moving a slider, turning a dial, or flicking a switch) may move the retaining member to allow the locking mechanism to pivot or retract out of the opening. The locking element may instead be biased in a position in which it extends into the opening and the release mechanism may be activated to force the locking element out of the opening against this biasing force to allow the fastening elements to be pulled apart. The locking element may be fixed to or integral with one of the fastening elements, and at least a part of it may be formed of a resilient material which can bend to allow the locking element to be forced out of the opening manually. Both fastening elements may comprise an integral locking element and/or an opening for a locking element of the other fastening element.

In embodiments, one or each of the first pair of fastening elements comprises a pivotable lever portion and a biasing means to bias the lever portion into a rest position in which it extends into the opening of the fastening element, and wherein the lever portions are pivotable by application of a force out of the respective opening to allow the locking element to be inserted and/or removed. If both fastening elements include a lever then both may include an opening into which the lever can extend. The fastening element may extend into both openings in the locked configuration of the securing device. The biasing means may be a spring, an elastic material, or another means which tends to force the lever portion towards its rest position. The rest position of the lever may represent a position in which the lever extends sideways and/or is angled downwards relative to the housing of the fastening element. Here the bottom of the housing is taken to be the part of the housing closest to the edge of the elongate member when the fastening element is attached to the sidewall and the top is the part of the housing closest to the contact surface or base of the member. The fastening element will also work, however, if the lever portion pivots in another direction into and out of the opening. The rest position can mean that the lever portion is angled upwards, for example, and the pivot point for the levers can be located below the level of the openings. This way the lever portions can be forced to swing downwards, rather than upwards, to move them out of the openings. The two lever portions can also be configured to pivot in opposite or different directions out of and into the openings in some cases. The force will usually be applied at or near to the free end of the lever portion to pivot it away from the opening, and a part of the lever arm closer to the pivot will be the part which extends into or across/through the opening in the rest position.

In embodiments, each of the first pair of fastening elements comprises a pivotable lever portion and the surface adapting assembly comprises the locking element and the locking element has a groove at either end for receiving the lever portions to prevent the locking element from being removed from the openings when the lever portions are in the rest position.

In embodiments, the surface adapting assembly comprises the locking element, and the locking element has a groove at either for receiving the lever portions to prevent the locking element from being removed from the openings when the lever portions are in the rest position. The securing device can therefore be transitioned from a locked to an unlocked configuration by pivoting of the two lever portions, and the locking element is able to be inserted into and removed from the fastening elements only when the lever portions of both fastening elements are pivoted away from the respective openings and the securing device is in the unlocked configuration. The pivoting can be achieved by use of a tool to apply the necessary force to pivot the lever portions out of the openings, as will be described below. The pivoting can alternatively be achieved via a user operated release mechanism of the type described above, where the activation causes the lever to pivot the lever portions out of the openings. The locking member will usually be inserted and removed through the front of the fastening elements, and the openings therefore extend from the front surface into the fastening element housings.

In embodiments, the surface adapting assembly comprises the locking element. In embodiments, the locking element is a separate part. In embodiments, this separate part may be removably attachable to the first pair of fastening elements. A separate part means that the locking element is not permanently attached to the fastening elements in any way. A string or similar may be used to tie the locking element to one of the fastening elements to prevent its loss, but this part is still removable and separate. The locking element is therefore easily replaceable if damaged.

In embodiments, the surface adapting assembly comprises a second securing device comprising a second pair of fastening elements attached to the second sidewall adjacent the second edge, with one of each pair being attached adjacent each end of the elongate member, wherein each fastening element has a height that is smaller than the distance across the sidewall from the second edge to the contact surface, and wherein at least one of the second pair of fastening elements comprises an opening for receiving a part of a locking element. If both fastening elements comprise an opening, then these may be configured for receiving the same locking element, so that the locking element can extend between the fastening elements. The inclusion of an additional second securing device on the second sidewall provides a particularly secure fixing means for the elongate member, and allows it to be used on reasonably fast-moving vehicles without the risk of it flapping or coming loose while still providing as continuous a contact surface as possible. In embodiments, the first and second securing devices are identical. These will also usually be attached in the same way and in a corresponding position to their respective sidewall.

In embodiments, the fastening elements abut one another when the locking element is inserted and the fastening elements are locked together. Abutting one another in this context means that the two facing (possibly interlocking) surfaces of the fastening elements are placed in contact with one another. To lock the securing device, the fastening elements are placed together so that they are abutting, and the locking element is inserted into the one or more openings to join them together. The locking element may be shaped to fit around an innermost portion of each fastening element when it is inserted into the openings, which prevents the fastening elements from being pulled apart when the locking element is inserted, or may be integral with one fastening element and configured to fit around an innermost portion of the other fastening element when inserted into the opening. The facing surfaces of the fastening elements may be shaped to provide two interlocking surfaces, such as being shaped with complimentary bumps and grooves, or may be flat. In both cases the two surfaces can abut one another. The abutting surfaces may not be continuous, i.e. the abutting surfaces of the elements may be formed as a U shape extending around the sidewall in a transverse cross-section. The end surfaces of the elongate member which are sandwiched by each of the two fastening elements will, in this case, also contact or sit directly adjacent one another when the fastening elements are locked together.

In embodiments, the first pair of fastening elements are arranged at each end of the elongate member in such a way that once the element is arranged on a tire, and the pair of fastening elements is locked together, the ends of the element will be in contact. In embodiments, the ends each comprise an end surface. These end surfaces may be facing and fixed in place directly adjacent one another when the fastening elements are joined together by the locking element. The two end surfaces may contact one another across their whole extent when the fastening means are locked together, or there may be a small gap in between, however this will, if present, represent empty space (filled with air only). The elongate member surface is then continuous or substantially continuous when the elongate member is fixed in place, which provides a smoother experience for the user. There are no additional elements or parts on the base of the elongate member or on the contact surface which may interfere with the operation of the vehicle.

In embodiments, the locking member is a bolt. The locking member may be a threaded bolt, and threaded openings may be provided in both fastening elements so that the bolt once inserted can fix the fastening elements together. The threaded openings may be located below the edge of the elongate member in the part of the fastening elements extending below this edge. The bolt may be insertable from the front of the two fastening elements or from the side of one of the elements.

In embodiments, the locking member is a cable, and the opening comprises or is fitted with a locking head for retaining the cable in place. This mechanism is similar to a cable tie, and the cable may be ridged.

In embodiments, the locking element is integral with one of the fastening elements and comprises a clip for providing a snap-fit with the opening in the other fastening element when the two fastening elements are pushed together. In embodiments, the clip comprises a tab, handle, or button which can be moved or pressed to cause the locking element to move out of the opening for detachment of the fastening elements from each other. In embodiments, the locking element comprises a hooked element and the opening is sized to receive an end of the hooked element. One or both of the pair of fastening elements may comprise an opening for a locking element integral with the other fastening element.

In embodiments, the first edge is a beaded edge. In embodiments, the pair of fastening elements are attached to the first sidewall at the first edge such that they extend up to or around the first edge. The combination of the beading and the fastening elements which extend up to or over the beading helps to stretch the cover over the tire and provides additional strength. The fastening elements may be fastened to the beaded edge of the elongate member, and this may be achieved by placement of the beaded edge within a recess of the fastening element. The recess may provide a tight fit for the beaded edge and the sidewall within the recess such that the cover is clamped and held within the recess.

In embodiments, the beading of the beaded edge comprises internal wiring extending along the length of the first edge and having a tensile strength that is higher than the rest of the elongate member.

According to a second embodiment, there is provided a method for manufacturing a surface adapting assembly for a tire, the method comprising: forming an elongate member including a contact surface having treads, a first sidewall extending longitudinally and extending between a first edge of the elongate member and the contact surface, a second sidewall extending longitudinally and extending between a second edge of the elongate member and the contact surface on the other side; and a first and second end extending in a transverse direction; and attaching a first pair of fastening elements to the first sidewall adjacent the first and second ends of the elongate member respectively, and adjacent the first edge, wherein each fastening element has a height that is smaller than the distance across the sidewall from the first edge to the contact surface, and wherein at least one of the first pair of fastening elements comprises an opening for receiving a part of a locking element. The method may be a method for producing a surface adapting assembly for a tire.

In embodiments, the method comprises forming the elongate member by moulding. The elongate member can be formed as a single piece, and may be formed by moulding a piece of the correct length, by cutting a larger piece to the correct length, or by moulding a tire-shaped member and later providing a slit in the member to form the two ends. The member may be formed of a polymeric material such as thermoplastic or rubber.

In embodiments, the fastening elements each comprise a recess and attaching the fastening elements to the sidewall comprises positioning the first pair of fastening elements so that the first edge is received within the recesses. This may involve fixing the fastening elements in place by passing a fixing means, such as a rivet, through the sidewall and the fastening element housing on either side of the sidewall. This provides a secure attachment means for the fastening elements and helps to pull the elongate member tight over the underlying wheel.

In embodiments, the method comprises providing the locking element. The locking element may be a shaped metal or plastic piece, for example, formed by moulding or stamping. The locking element is easy and cheap to produce, and can also be replaced easily if required.

According to an example, there is provided a surface adapting assembly for a tire comprising an elongate member for fitting over the tire, the elongate member having: a contact surface comprising treads; a first sidewall extending longitudinally and extending between a first edge of the elongate member and the contact surface; a second sidewall extending longitudinally and extending between a second edge of the elongate member and the contact surface on the other side; and a first and second end extending in a transverse direction; wherein the surface adapting assembly comprises a first pair of fastening elements attached to the first sidewall adjacent the first edge, and with one of each pair being attached adjacent each end of the elongate member, wherein at least one of the first pair of fastening elements comprises an opening for receiving a part of the same locking element. In embodiments, the fastening elements each comprise a recess to accommodate a part of the first edge of the elongate element.

In embodiments, the first pair of fastening elements are arranged at each end of the elongate member in such a way that once the element is arranged on a tire, and the pair of fastening elements is locked together, the ends of the element will be in contact. In embodiments, the surface adapting assembly comprises the locking element. In embodiments, the fastening elements each extend below the edge of the elongate member, and the opening is positioned so that when the locking member is received therein it extends between the fastening elements below the edge of the elongate member.

### BRIEF DESCRIPTION OF THE DRAWINGS

Embodiments of the present invention will now be described, by way of example only, with reference to the following diagrams wherein:

FIG. 1 illustrates a standard tire fitted with a surface adapting assembly including an elongate member and securing device;

FIG. 2 shows a close-up of the securing device for fixing the elongate member in place and an example tool for unlocking the securing device;

FIG. 3A is a rear view the securing device in a locked configuration;

FIG. 3B illustrates the unlocked configuration of the device shown in FIG. 3A;

FIG. 4 shows a front view the securing device of FIGS. 3A and 3B in its locked configuration;

FIG. 5 is a side view of a fastening element on its own (left) and fitted with a locking element (right);

FIG. 6A shows one of two fastening elements, an insert, and just the lever portion of the other fastening element with the securing device in its locked configuration;

FIG. 6B shows the assembly of FIG. 6A in the unlocked configuration;

FIG. 7A is a perspective view of a part of the assembly of FIGS. 6A and 6B in the locked configuration;

FIG. 7B shows a perspective view of a part of the assembly of FIGS. 6A, 6B, and 7A in the unlocked configuration;

FIG. 8A is a perspective view of a locking member;

FIG. 8B is a perspective view of a lever portion;

FIG. 8C is a perspective view of the locking member and two lever portions in a locked configuration of the securing device;

FIG. 9 is a cross section through two fastening elements with a locking element inserted and extending between in the locked configuration;

FIG. 10 shows an exploded view of the two fastening elements and locking element about to be inserted;

FIG. 11 illustrates an elongate member and two securing devices, one on either sidewall of the elongate member in a cross-sectional view;

FIG. 12A shows an alternative configuration for the securing device with a locking element insertable from the side;

FIG. 12B shows an alternative configuration for the securing device with a locking element insertable from the front;

FIG. 12C shows an alternative configuration for the securing device with a locking element in the form of a cable;

FIG. 12D shows an alternative configuration for the securing device with a locking element that is integral with one of the fastening elements and configured to fit within an opening in the other fastening element;

FIG. 12E shows an alternative configuration for the securing device similar to that of FIG. 12D but with an additional band to assist in securing the fastening elements together;

FIG. 12F shows an alternative configuration for the securing device wherein the locking element and opening together represent a clipping mechanism; and

FIG. 12G shows an alternative clipping configuration for the securing device.

### DETAILED DESCRIPTION

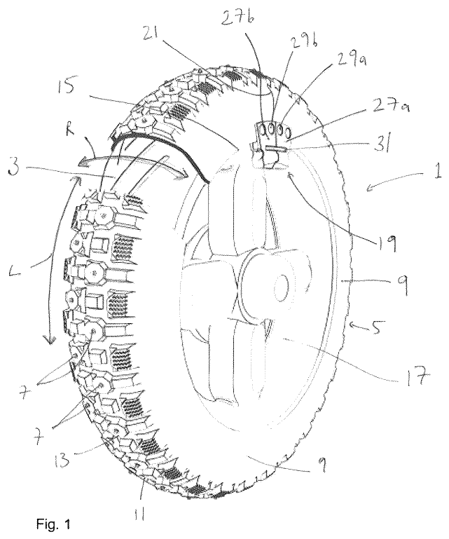

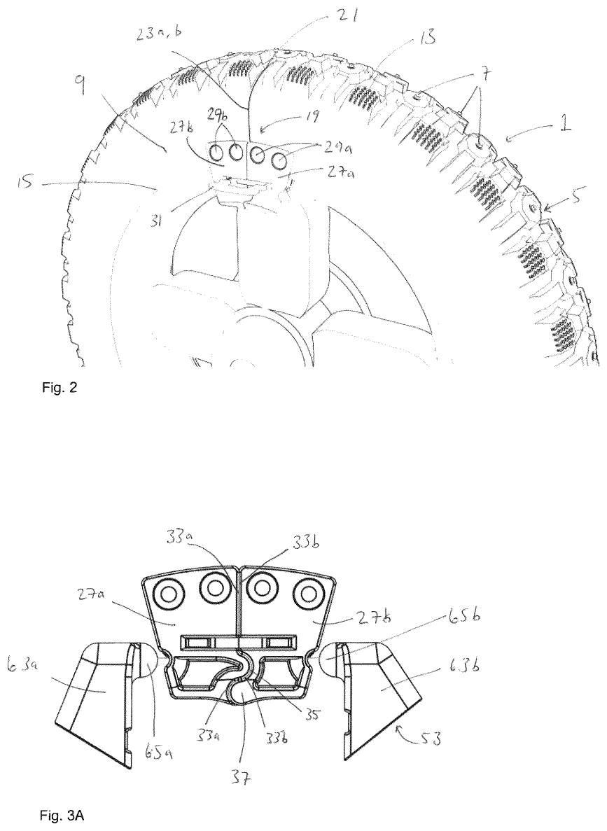

An example of surface adapting assembly 1 for a tire is shown in FIGS. 1 and 2, fitted over a base tire 3. The assembly includes an elongate member 5 which covers the tire when the assembly is fitted. A section of the elongate member 5 is cut-away in FIG. 1 to show a part of the original tire 3 beneath, which in this case is provided with treads of a different type to the elongate member, more suitable for summer weather. The base tire 3 may be a standard tire or may be a structure specifically designed to assist with attachment of the elongate member 5 using a securing device 19. The elongate member 5 itself can comprise deep grooves and spikes 7 for additional grip and is formed, for example by moulding, into a tire-shaped skin with sidewalls 9 and a base 11 including an outer contact surface 13 on which the treads and in this case also spikes are located. Each of the two sidewalls 9 extends between the contact surface 13 and an edge or rim 15 which is designed to sit close to the wheel hub 17. The elongate member 5 itself will usually be rotationally symmetrical about an axis coincident with the wheel axis and will be identical on each side, so that it can be installed on a wheel with the two sidewalls 9 facing in either direction. In general, a securing device 19 will be provided on either sidewall close to or at the edge of the elongate member in order to provide a secure connection, but if only one is provided then for a four-wheeled vehicle such as a car or a mobility scooter it may be convenient for the elongate member to be fitted so that the sidewall with the securing device attached faces outwards in relation to the vehicle itself, making the securing device easier to access. Securing devices may also be provided on both sidewalls, as described below. The material of the elongate member may be formed of any flexible, elastomeric, or polymeric material, for example rubber or thermoplastic elastomers, with or without fiber inserts. Additional layers, such as fiber inserts forming a strengthening woven layer, may also be present. The fastening elements and locking element can be formed of any solid material with high enough stiffness to allow the locking mechanism to function properly. These can be formed of, for example, plastic, composites, fiber-reinforced materials, metal, and the like.

The elongate member 5 can be sized to extend all of the way around the wheel in both the longitudinal direction and in a generally radial direction over the underlying base tire from the wheel rim on one side to the wheel rim on the other side. The elongate member of the assembly does, however, include two ends which form a split 21 extending radially across it when it is fitted over a tire. The split extends from one edge of the elongate member, up one sidewall, across the contact surface, and down the other sidewall to the opposite edge to completely divide or separate the two portions of the elongate member on either side. The slit will usually be straight and extending perpendicular to the longitudinal extent of the elongate member L but, in some examples, it extends diagonally across the elongate member or is shaped with waves or grooves to provide two interlocking ends. A straight slit 21 extending across the member via shortest distance between two edges as shown in FIGS. 1 and 2 is generally preferable, however, since this minimises the length of the slit which can represent a weak point in the assembly. The ends 23a and 23b of the elongate member are separated at the slit, and provide end surfaces which sit adjacent one another when the assembly 5 is fitted.

Although the elongate member may be formed of a semi-rigid material (such as rubber) which means that it generally holds its rounded shape even when not fitted over a tire, the two ends of the elongate member can be pulled apart to remove the elongate member from a wheel to which it is fitted. This allows the elongate member to be easily placed over the underlying tire structure by stretching it slightly to separate the ends so that the wheel can be passed in between, or the elongate member can be placed around the wheel from one side because of an increase in the size of the generally circular opening around which the elongate member extends. As mentioned, the material of the elongate member will usually be such that it is resilient and tends to spring back to a tire-shaped form, as shown in FIG. 1, when no force is applied. The entire wheel then does not need to be replaced in order to provide a different wheel surface, and the elongate member can be used with any underlying wheel, tire, or structure provided that the correct size of elongate member is chosen. This is extremely convenient for a user, is usable with any standard base tire, and means that changing a tire surface can be achieved easily and with minimal additional equipment.

When referring to the elongate member and wheel, a longitudinal direction refers to the direction around the perimeter of the circular wheel when the elongate member is fitted, or along the longest dimension of the elongate member from end to end. This is shown as direction L in FIG. 1. The radial direction extends in a plane perpendicular to this. The radial direction is shown as direction R in FIG. 1. In order to secure the ends of the elongate member 5 together once the elongate member is in place, a securing device 19 is provided as part of the surface adapting assembly 1. The securing device 19 comprises two fastening elements 27a and 27b which each include attachment means 29a;b to allow them to be secured to the elongate member at each end, so that they sit one on either side of the slit 21 when the assembly is fitted. One or more locking elements 31 are then used to secure the two fastening elements together. The locking element can be an integral part of one or each of the fastening elements, or can represent a physically separate element or elements designed to be placed between the fastening elements to lock or hold them together, and to prevent them from moving apart from one another.

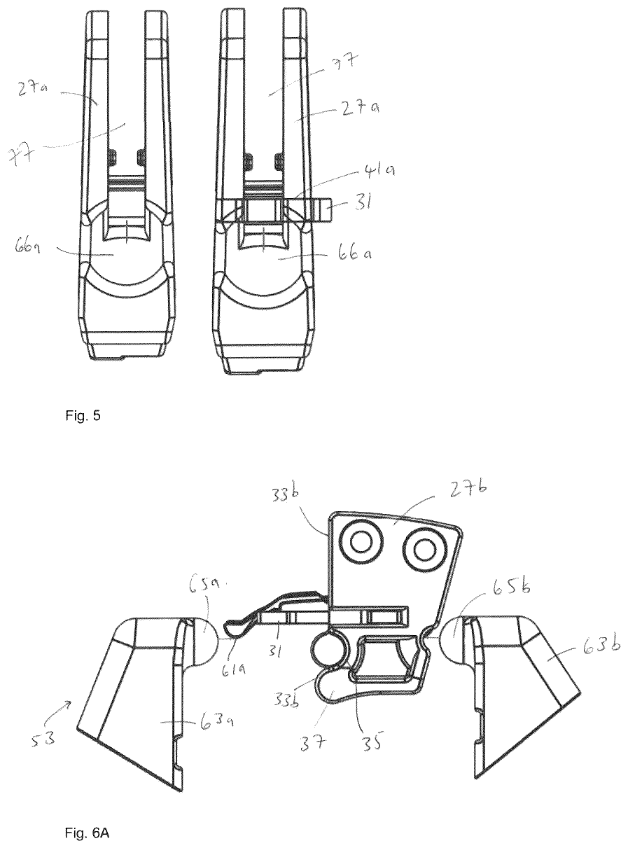

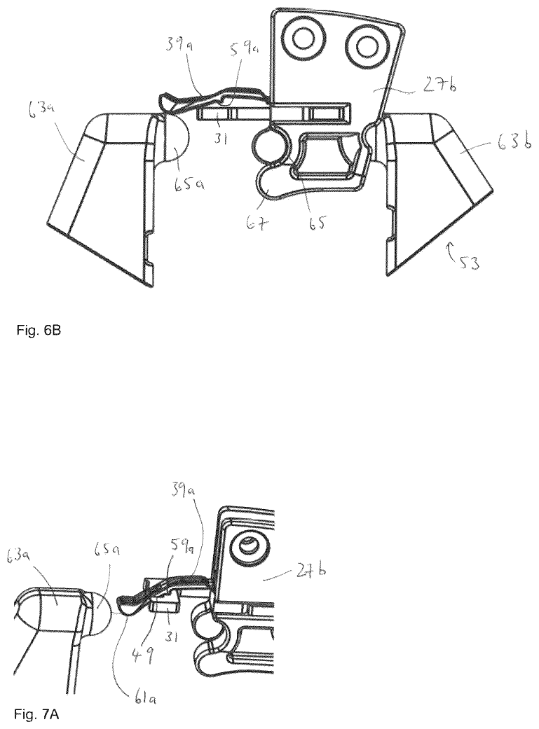

The most convenient location for the fastening elements is one at either end of the elongate member 5, on a sidewall 9, and adjacent the edge 15 of that sidewall. This means that the fastening elements are located on a part of the sidewall that is furthest from the contact surface and closest to the wheel hub or rim when the assembly is installed. The fastening elements also have a height that is smaller than the height of the sidewall so that they extend only a part of the way from the edge up towards the contact surface. This positioning means that the presence of the securing device does not interfere with movement of the wheel or the operation of the vehicle. The fastening elements 27a;b are preferably attached to the elongate member so that when the surfaces 33a;b of the fastening elements are positioned so that they are abutting, the two ends 23a;b of the elongate member sit directly adjacent, and preferably in contact with, one another. The abutting surfaces 33a and 33b may be flat surfaces or may be shaped so that they interlock. The abutting surfaces in the example shown in FIGS. 3 to 10 include curved indents 35 and protrusions 37 which fit into corresponding indents and protrusions of the other element in the pair. The fastening elements 27a and 27b are held in contact with one another using the locking element 31, which consequently also maintains the end surfaces of the elongate member together so that the slit 21 is closed. The attachment means 29, which couple each fastening element to an end of the elongate member, may be rivets, such as metal rivets.

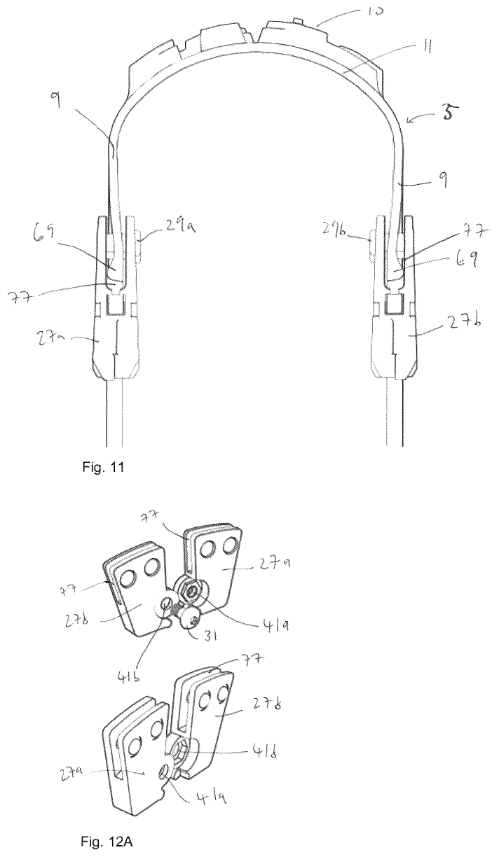

The edges 15 of the sidewalls on either side of the elongate member may comprise beading 69, which may extend along the entire length of the edge on one or both sides. The beading can be formed by including a wire or elongate portion of a different material embedded within the base material at the edges only, and/or may be formed as a thicker or bulbous portion of the sidewalls. The material within the beading may have a tensile strength that is higher than that of the rest of the tire, so that it stretches less easily. The material of the beading must have a sufficiently high resistance to stretching, and can comprise Kevlar (para aramide) fibers, nylon fibers, metal wires, and the like. The beading may help to pull the elongate member tightly over the tire, which will be especially effective in combination with fastening elements which are coupled to the beading or extend around and are fastened over the beading. When the fastening elements are coupled together, the two ends of the beading will sit directly adjacent each other to form a hoop which can pull the elongate member around the tire. The most effective configuration will include two sets of beading, one along either edge, and a securing devices on each of the first and second sidewalls. Each securing device will comprise a pair of fastening elements coupled to either end of one of the sets of beading. FIG. 11 shows an example of a surface adapting assembly for a tire including two securing devices. These each comprise a pair of fastening elements which extend around one of the first and second edges of the elongate member and which extend across both the outer and inner surfaces of the relevant sidewall up towards (but not all the way to) the contact surface. The edge of the elongate element is therefore received within a recess 77 in the fastening element housing. The attachment means, 29a and 29b, are rivets in this example, which extend through the fastening element on both sides of the sidewall and through the sidewall itself, which is sandwiched in between. The beaded edge of the elongate member is visible beneath the rivets, and the openings for the locking member are located beneath the edge of the elongate member. The fastening elements thus extend both around and below the edges of the elongate member in this case. The interference with the elongate member itself due to parts of the securing device extending across the elongate member is minimal.

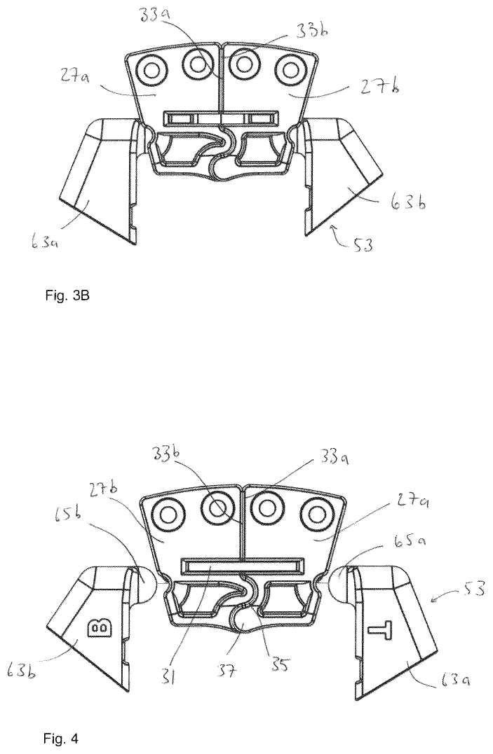

One example of a securing device 19 including fastening elements 27a;b and a locking element 31, which can be used to secure an elongate member 5 in place, is shown in FIGS. 1 to 7. FIGS. 3A and 3B show the device from the rear, and FIG. 4 shows the device from the front. In the embodiment shown in FIGS. 1 to 7, the fastening elements 27a;b each comprise a housing which contains a lever portion 39a and 39b respectively. The lever portion is able to swing up and down about a pivot point, which is located adjacent the abutting surfaces of the two fastening elements. This pivoting motion of the lever portions transitions the securing device from an unlocked position (levers up) to a locked position (levers down), as will be described in more detail below. The free end of the lever portion can extend outward of the housing or be accessible through an opening in the housing or by lifting a cover. The lever portions may be permanently fixed inside the fastening elements, or may be detachable and removable.

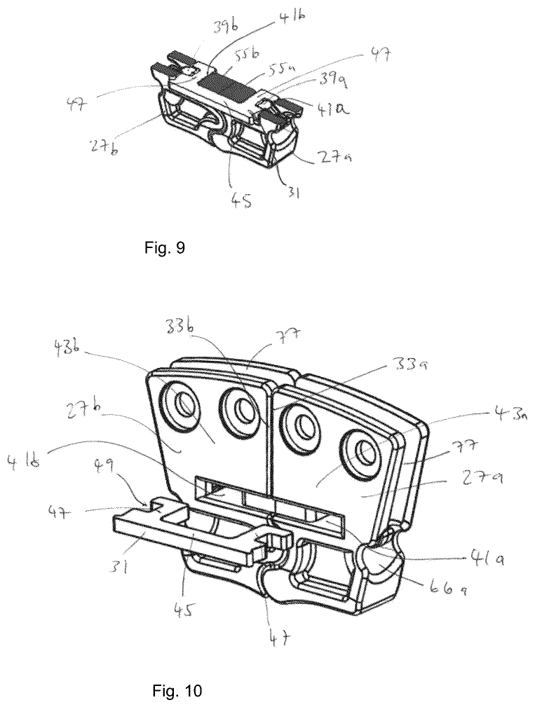

The locking element 31 comprises an insert which is shaped to be passed through openings 41a;b in the front or back face of each fastening elements so that it extends between the two as shown most clearly in FIGS. 9 and 10. In the example shown, the openings extend through the front faces 43a and 43b of the two fastening elements 27a and 27b respectively.

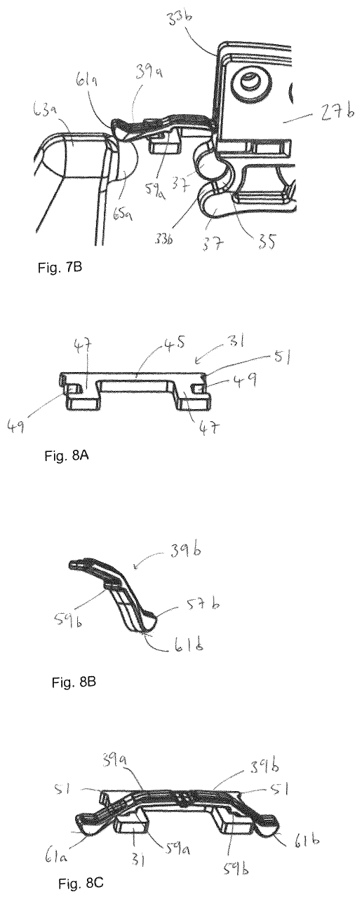

The locking element 31, shown as a separate component in FIG. 8A, is a generally u-shaped element comprising a body 45 and two rearwardly extending legs 47 at either end. The legs are each provided with grooves 49 in their outward facing edges in which the free end of a lever portion can sit when the securing device is in its locked configuration, as is shown in FIG. 8C. The front side of the locking element can also include a lip 51 to prevent ingress of dust and dirt, to make removal of the locking element easier, and to provide a more aesthetic front surface for the device in its locked configuration. The fastening elements themselves are each shaped with an opening 41a;b through the housing which are each sized to receive one of the locking element legs. These openings extend all of the way through the housing from front to back in the example shown, which provides a more secure connection, however this need not necessarily be the case. Once the locking element has been pushed in through the front of the fastening elements so that each of the legs is inserted into one of the openings, the two fastening elements cannot be pulled apart. The locking element itself is maintained in position using the lever portions and grooves, as will be explained below. The levers are optional, but help to provide a more secure connection and prevent the locking element from sliding out of the openings during use.

To fit an elongate member 5, the ends 23a;b are pulled apart and the elongate member 5 is placed over the underlying wheel or tire by passing it between the two ends or through the side of the larger opening surrounded by the elongate member. After this, the ends are allowed to come back together so that the elongate member fits over the wheel below and the abutting surfaces 33a;b of the fastening elements 27a;b are in contact with one another. A tool 53 is used to lift the two lever portions 39a;b within the fastening element housings to transition the securing device into its unlocked configuration, and the locking element 31 is pushed in through the front of the fastening elements so that the legs 47 of the locking element extend into the openings 41a;b and the body 45 sits against a portion of the fastening element housings. The tool 53 is removed so that the lever portions 39a;b drop into the grooves 49 of each arm of the locking element. The securing device is now in its locked configuration. The lever portions 39a;b prevent the locking member 31 from being pulled out without re-using the tool or a similar device, and the locking element joins the two fastening elements together so that they cannot be pulled apart.

FIG. 9 is a cross sectional view of the two fastening elements 27a;b with the locking member 31 in place and extending between the two. This clearly shows the shape of the openings 41a;b extending through both fastening elements into which the legs 47 of the locking element 31 are fitted. Here, the lever portions 39a;b are also rotated downwards so that the securing device is in the locked configuration. The openings 41a;b extend from the front to the back of the fastening elements so that the legs of the locking element can pass all of the way through, but this need not be the case, as mentioned above. This type of locking element will function provided that, once inserted, a part of one or each of the fastening elements inward of the opening (in the example shown in the figures parts 55a;b) is positioned between the abutting faces 33a;b, or the facing surfaces, of the fastening elements and the locking element when the locking element is installed. This way the locking element can prevent the fastening elements from moving outwards and away from each other.

FIG. 8C illustrates the position of the two lever portions 39a;b when the securing device is in its locked configuration and the free ends 57a;b of the lever portions sit within the grooves at either end of the locking element. When the locking element 31 is in place extending between the two fastening elements and the lever portions are pivoted downwards to sit within the grooves 49 as shown, the locking element cannot be pulled out back through the openings 41a;b provided in the front face of the fastening elements and the fastening elements are securely held together.

The lever portions 39a;b may each be provided with biasing elements, such as springs, to encourage them to pivot downwards into the grooves 49. To transition the securing device into its unlocked position, the lever portions can be pivoted upwards (against the action of the biasing means if present). The free ends 57a;b of the lever portions then no longer sit within the grooves 49 at either end of the locking element 31 and the locking element can be pulled out so that the fastening elements are free to be pulled apart. This way the elongate member can be easily removed and replaced.

The lever portions 39a;b may be shaped as shown in FIG. 8B to include a lip 59a;b way along the underside and a curved end portion 61a;b also on the underside and nearest to the free end 57a;b of the lever. These parts each have a specific function as will be described below, and can improve the smooth functioning of the securing device. These shaped portions are, however, not required to be present and can be dispensed with in some cases. The lip 59a;b is designed to sit so that its lower surface is flush with an upper surface of the locking element 31 at the inner edge of the groove 49 when the securing device is in its locked configuration. FIG. 8C shows the two lever portions 39a;b and the locking element 31 in the locked configuration, with the housing of the fastening elements omitted. If a biasing element is used to force the lever portions downwards, the lip will help to provide a stop for the lever portions. It will also help the lever portions to sit securely and to remain correctly positioned within the grooves of the locking element when the securing device is in the locked configuration.

The rounded lower edge 61a;b of each of the free ends 57a;b of the two lever portions 39a;b provides a for smoother operation when the lever is pivoted upwards to transition the securing device from its locked to its unlocked configuration. This transition is achieved using a tool 53 which forces the lever portions upwards and out of the grooves of the insert. The tool 53 itself is insertable either side of the securing device through each of the fastening element housings to push the free end of the lever upwards. The tool 53, in one example, is shown in FIGS. 3A, 3B, 4, 6A, 6B, 7A, and 7B. The two tool elements 63a;b shown in the figures may represent the jaws of a larger tool also including a handle for carrying and for moving the jaws together and apart. The tool may have a design similar to a pair of plyers, for example, which is an advantage in that the tool can also help to maintain the fastening elements in position while the locking member is being inserted. In other examples the two tool elements 63a;b may be completely separate parts, each of which is able to be individually pushed in through the side of either fastening element. Generally, the tool elements will be identical and so the jaws of the tool or the two tool elements can each be used with either fastening element. The action of the tool 53 is illustrated in FIGS. 3A, 4, 6A, and 7A (locked configuration) and FIGS. 3B, 6B, and 7B (unlocked configuration). As can be seen from these figures in particular, the tool includes at least one jaw 63a;b having a domed portion 65a;b which can be inserted into the housing of the fastening element so that it contacts the curved underside 61a;b of the lever portion 39a;b. Inserting the dome portion in further results in the curved portion of the lever sliding over the domed surface so that the lever is caused to swing upwards and away from the locking element. The combination of the domed head of the tool and the curved underside of the lever portion results in a smooth action as the tool jaw 63a;b is pushed into the housing and the lever portion is lifted. Both the jaw and lever can be differently shaped, however. If a separate tool is provided, which includes both jaws 63a and 63b, then a squeezing action on the handle may cause the two jaws to move towards each other and into the fastening element housings. Although providing a tool which allows the levers to be pivoted at the same time and the locking element removed straight out of the housing is more convenient, in some cases the levers can be separately pivoted and the corresponding arms of the locking element removed from the openings one by one.

FIG. 5 illustrates the shape of the fastening element housing from the side (with and without the locking element present). A generally circular opening 66a corresponding in size to or slightly bigger than the domed head of the tool jaw is visible in this figure. Another, similar, opening will be present on the other fastening element of the pair. This allows the lever to be accessed without requiring the free end of the lever to protrude outward of the rest of the fastening element housing, and helps to protect the more delicate lever portions from damage. The circular opening 66a in the housing is also visible at the right-hand side of the rightmost fastening element 27a in FIG. 10.

The use of a separate tool 53 makes it more difficult to accidentally unlock the device, which is an advantage. In some cases, rather than using a tool, the fastening elements themselves can instead be provided with one or more switches or sliders which can be pressed or moved to pivot the levers in some cases. Elements similar to the tool jaws shown in the figures can also be fixed to the fastening element, for example by way of a pivoting connection, so that they can be pushed inwards to lift the levers and release the insert. In such cases a separate tool will not be required. Clearly, the lever portions can be configured to pivot into the openings from another direction rather than downwards as in the example shown. Rather than pivoting, the lever portions can move into and out of the opening in another way, such as a linear motion downwards/upwards/sideways.

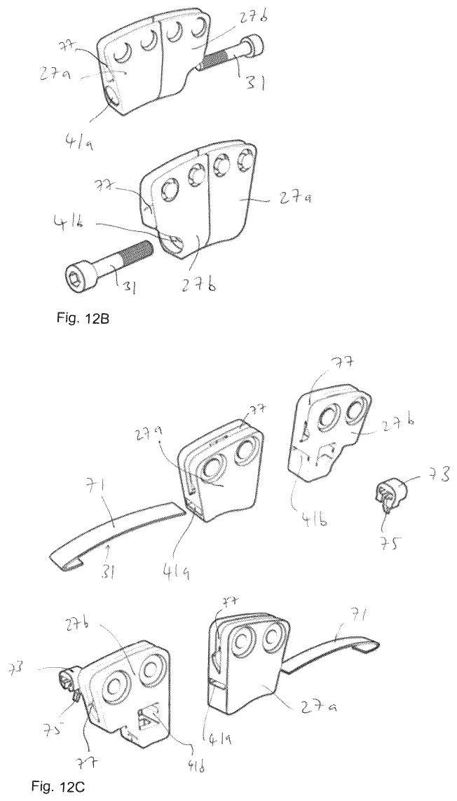

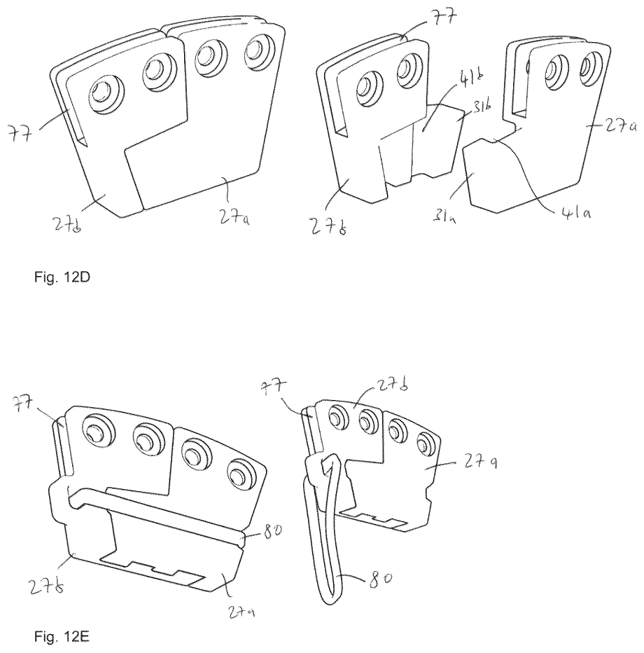

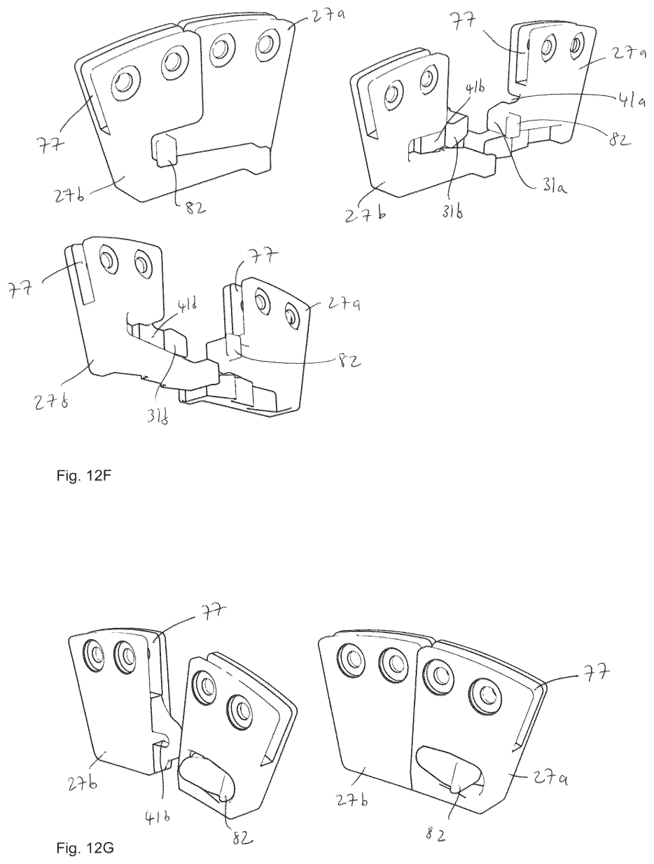

In FIGS. 12A, 12B, and 12C, some alternative configurations for the fastening and locking elements are shown. FIG. 12A illustrates an embodiment wherein both fastening elements 27a;b include a threaded opening 41a;b, and the locking element 31 is a threaded screw which is inserted through the openings in both fastening elements from a front side or a back side. The fastening elements are again thin in profile, so that they do not project forward or rearward of the sidewall to which they are attached, but do extend inwards towards the wheel axis and below the sidewall edge. The openings 41a;b are generally located in the part of the fastening element extending below the sidewall edge. Again, the facing sides of the fastening elements have corresponding, interlocking shapes so that when the elongate member is fixed in place the compound fastening element is compact and has a smooth outer surface.

In FIG. 12B, the two fastening elements 27a;b include facing surfaces with holes therethrough which form the openings, and the locking element 31 comprises a threaded screw which can be passed through the two holes from the side of one of the fastening elements. The fastening elements are fixed to the ends of the elongate member as above using rivets or similar attachment means 29a;b. The fastening elements comprise only a section for attaching to the sidewall of the elongate member adjacent the ends and a section including the facing surface 33a;b and having a hole provided therethrough. The fastening elements in all cases can extend around a part of the edge 15 of the elongate member 5 as shown in the figures. The locking element shown in FIGS. 12A and 12B is a threaded screw, however any type of locking element can be used, provided that it can be inserted through an opening in one or both fastening elements in order to hold them together in a locked configuration. Both of the examples shown in FIGS. 12A and 12B can use bolts without threads, for example, which are held in place within the openings of the fastening elements using pins, clips, projections, or any other retaining mechanism.

FIG. 12C shows a fourth example using a mechanism similar to a zip-tie to couple the two fastening elements 27a;b together. One fastening element 27a includes an opening 41a in the shape of a slot for receiving the cable 71 of the tie, and the other element includes an opening 41b for receiving a locking head 73 for coupling to the cable. A clipped projection 75 may be included to help to retain the locking head within the opening 41b or to help with release of the cable. The head 73 may be inserted into the opening 41b of the fastening element from any direction, but in the example shown is inserted from the side. Once the locking head is in place, the cable can be passed through both fastening elements and through the locking head to fix the fastening elements together. Removal will require the application of some force, as for a normal zip-tie. Obviously, different mechanisms for coupling the two fastening elements together, including openings of different shapes and locking elements having different configurations, can be conceived of. In all cases there are present two fastening elements and a locking element, which can be inserted or moved in order to extend between the two fastening elements to fix them together adjacent one another. The fixing of the fastening elements together will hold the elongate member to which they are fixed in place over the vehicle tire.

Some additional configurations for the locking element and the fastening elements are shown in FIGS. 12D to 12G. In the example shown in FIG. 12D, fastening elements 27a;b have integral locking elements. The locking element is in the form of a hooked extension 31a;b which extends into an opening 41a;b in the other fastening element when the two are locked together. The two hooks couple together, and the opening in this case comprises the indent formed as the inward facing part of the hook of each fastening element. The fastening elements 27a;b can be locked together by moving the two towards each other in a direction perpendicular to the longitudinal extent of the elongate member to which they are attached. The two fastening elements are pushed together sideways so that the hooked locking elements 31a;b are coupled together as shown on the left side of FIG. 12D. The fastening elements 27a;b cannot then be pulled apart by a force applied in a longitudinal direction relative to the elongate element, i.e. a force applied to pull the ends of the elongate member apart. A securing device 80 can be included to help to prevent unwanted sideways movement of the two fastening elements relative to one another. An example of a securing device for this use is shown in FIG. 12E. Here the securing device 80 is an elastic band or similar, which can be attached to one fastening element and can be stretched to extend over the other fastening element. The securing device can take different forms, such as a clip, a hinged fastener, or a solid clasp which extends over both fastening elements. The securing device can be provided as separate from the two fastening elements in some cases.

Alternative clipping mechanisms are shown in FIGS. 12F and 12G. As for the examples shown in FIGS. 12D and 12E, the locking element 31a;b represents part of a clip which extends into an opening 41a;b in the opposite fastening element to lock them together. The extensions forming the ends of the clip may be resilient, so that the extension can be bent outwards slightly to push the two fastening elements into place. These types of clipping mechanisms are easy to operate manually. Additional buttons, handles, slides, or tabs 82 can be included to aid in unclipping the fastening elements 27a;b from one another. The example shown in FIG. 12F includes small handles at the ends of the clips to allow the devices to be unclipped more easily. The example in FIG. 12G includes a tab which allows the locking element 31a;b to be easily removed from the opening by pressing of the tab inwards towards the body of the fastening element. Some examples (including those shown in FIGS. 12D, 12E, and 12F) include two openings and two locking elements, one on each of the fastening elements, while other examples (such as that shown in FIG. 12G) include a fastening element with an opening and another with a locking element.

The securing device in all cases is very simple, light, and cheap to produce. This type of device may be particularly suitable for use on a smaller vehicle such as a bicycle or scooter. The locking device generally extends between the two fastening elements in a region of the fastening elements extending below the edge of the elongate member (and below the rim of the underlying tire). This means that the securing device as a whole does not need to extend outwards to either side, and can be thin in profile, which reduces the likelihood of damage or of the securing device hitting objects during use.

Another possible variation is to include an integral locking element comprising two magnets coupled to each of the fastening elements in facing surfaces thereof. The magnets are sufficiently strong to hold the fastening elements together, and the elongate member in place, while the wheel is in use. Again, this type of design will be better suited to a smaller vehicle. Any of the securing devices described above can, in some embodiments, be provided with additional components such as sensors to provide information about the speed of the vehicle or external conditions when the vehicle is in use. These sensors can also be designed to detect a transition of the securing element to the unlocked configuration, so that accidental detachment of the elongate member can be avoided.

1-20. (canceled)

21. A surface adapting assembly for a tire comprising an elongate member for fitting over the tire, the elongate member having:
a contact surface with treads;
a first sidewall extending longitudinally and extending from a first edge of the elongate member to a first side of the contact surface;
a second sidewall extending longitudinally and extending from a second edge of the elongate member to a second side of the contact surface; and
a first end and a second end, each extending in a transverse direction, wherein
the surface adapting assembly comprises a first pair of fastening elements attached to the first sidewall adjacent the first edge, with one fastening element of the pair being attached adjacent one of the first and second ends and the other fastener element of the pair being attached adjacent the other of the first and second ends of the elongate member,
each fastening element has a height that is less than a distance across the sidewall from the first edge to the contact surface,
at least one of fastening elements of the first pair of fastening elements comprises an opening for receiving a part of a locking element.

22. The surface adapting assembly according to claim 21, wherein both of the fastening elements of the first pair of fastening elements comprises an opening for receiving a part of the same locking element.

23. The surface adapting assembly according to claim 21, wherein each of the fastening elements of the first pair extends from the first edge to a location between ⅙ and ¾ of the way across the outer surface of the first sidewall.

24. The surface adapting assembly according to claim 21, wherein each of the fastening elements of the first pair comprises a recess to accommodate the first edge of the elongate member.

25. The surface adapting assembly according to claim 24, wherein the first edge comprises beading extending from the first end to the second end and the recess accommodates the beading.

26. The surface adapting assembly according to claim 21, wherein the each of the fastening elements of the first pair extends below the first edge of the elongate member, and the opening is positioned so that when the locking element is received therein it extends between the fastening elements below the first edge of the elongate member.

27. The surface adapting assembly according to claim 21, wherein each of the fastening elements of the first pair is arranged at the respective end of the elongate member such that when the elongate member is arranged on a tire and the pair of fastening elements is locked together, the ends of the elongate member are in contact with one another.

28. The surface adapting assembly according to claim 21, wherein one or each fastening element of the first pair comprises a pivotable lever portion and a biasing means to bias the lever portion into a rest position extending into the opening of the fastening element, and
the one or more lever portions is pivotable by application of a force out of the respective opening to allow the locking element to be inserted, removed or both.

29. The surface adapting assembly according to claim 28, wherein
each fastening element of the first pair comprises a pivotable lever portion and
the surface adapting assembly comprises the locking element and the locking element has a groove at either end for receiving the lever portions to prevent the locking element from being removed from the openings when the lever portions are in the rest position.

30. The surface adapting assembly according to claim 21, comprising the locking element.

31. The surface adapting assembly according to claim 30, wherein the locking element is a separate part.

32. The surface adapting assembly according to claim 21, comprising a second pair of fastening elements attached to the second sidewall adjacent the second edge, with one of each pair being attached adjacent each end of the elongate member, wherein each fastening element has a height that is smaller than the distance across the second sidewall from the second edge to the contact surface, and wherein at least one of the fastening elements of the second pair comprises an opening for receiving a part of a locking element.

33. The surface adapting assembly according to claim 32, wherein the first and second pairs of fastening elements are identical.

34. The surface adapting assembly according to claim 21, wherein the first edge is a beaded edge.

35. The surface adapting assembly according to claim 34, wherein the beading of the beaded edge comprises internal wiring extending along the length of the first edge and having a tensile strength that is higher than the tensile strength of the rest of the elongate member.

36. The surface adapting assembly according to claim 21, wherein the pair of fastening elements are attached to the first sidewall at the first edge such that they extend up to or around the first edge.

37. A method for manufacturing a surface adapting assembly for a tire, comprising:
forming an elongate member including a contact surface having treads, a first sidewall extending longitudinally and from a first edge of the elongate member to a first side of the contact surface, a second sidewall extending longitudinally and from a second edge of the elongate member to a second side of the contact surface opposite the first side, and a first end and second end extending in a transverse direction; and
attaching a first pair of fastening elements to the first sidewall adjacent the first end and second end of the elongate member, and adjacent the first edge, wherein
each fastening element has a height that is less than a distance across the sidewall from the first edge to the contact surface, and
at least one of the first pair of fastening elements comprises an opening for receiving a part of a locking element.

38. The method of claim 37, wherein the elongate member is formed by moulding.

39. The method of claim 37, wherein
each of the fastening elements of the pair comprises a recess, and
attaching the fastening elements to the sidewall comprises positioning the first pair of fastening elements so that the first edge is received within the recesses.

40. The method of claim 37, comprising a step of providing the locking element.
